(19) United States
(12) Patent Application Publication
(10) Pub. No.: US 2023/0418798 A1
(43) Pub. Date: Dec. 28, 2023

(54) INFORMATION PROCESSING APPARATUS AND INFORMATION PROCESSING METHOD

(71) Applicant: Fujitsu Limited, Kawasaki-shi (JP)

(72) Inventor: Kazuhiro URATA, Kawasaki (JP)

(73) Assignee: Fujitsu Limited, Kawasaki-shi (JP)

(21) Appl. No.: 18/299,570

(22) Filed: Apr. 12, 2023

(30) Foreign Application Priority Data
Jun. 22, 2022 (JP) 2022-100367

(51) Int. Cl. G06F 16/22; G06F 16/215

(52) U.S. Cl. CPC G06F 16/2255; G06F 16/215

(57) ABSTRACT

An information processing apparatus includes a storage that stores, in a state where a physical storage area in which data requested to be written to a logical storage area is to be stored without duplication is divided into a plurality of partial storage areas, each includes a plurality of unit storage areas, and where the plurality of partial storage areas are grouped in a plurality of groups, a management table in which a record associated with each of the unit storage areas is registered. The management table is divided into group regions in each of which, the records associated with the unit storage areas included in the partial storage areas belonging to the associated group among the plurality of groups are registered, each of the records contains a first hash value based on data in the associated unit storage area and location information of the associated unit storage area.

### CROSS-REFERENCE TO RELATED APPLICATION

This application is based upon and claims the benefit of priority of the prior Japanese Patent Application No. 2022-100367, filed on Jun. 22, 2022, the entire contents of which are incorporated herein by reference.

### FIELD

The embodiments discussed herein are related to an information processing apparatus and an information processing method.

### BACKGROUND

As one of techniques of a storage system, there has been known a technique called “deduplication” for efficiently using a storage area in a storage device by precluding redundant data from being stored in the storage device. In the deduplication technique, in many cases, the determination on data duplication includes comparing hash values calculated based on respective data pieces, instead of comparing the original data pieces. In this case, a hash value based on data stored in each unit storage area is managed in, for example, a management table.

In the deduplication technique, a reference counter indicating the number of references from data before deduplication is counted for each unit storage area that is a data storage unit in a storage device. The reference counter may be decremented by subtraction according to a data deletion request. When the reference counter becomes “0”, the associated unit storage area is no longer referred to from anywhere, and thus the hash value for the data in this unit storage area is unnecessary among the hash values in the management table.

Regarding the deduplication technique for storage, the following techniques have been proposed. For example, a storage system has been proposed in which chunk statistical information including a deduplication effect value of each stored chunk data is used to search for stored chunk data matched with storage target chunk data. A storage system has also been proposed in which each container is composed of mutually highly relevant chunks, so that, in restoring a content in restore processing, multiple chunks constituting the content may be acquired by reading the one container.

International Publication Pamphlet No. WO 2016/006050 and Japanese Laid-open Patent Publication No. 2020-47107 are disclosed as related art.

### SUMMARY

According to an aspect of the embodiments, an information processing apparatus comprising a storage and a processor, wherein the storage is configured to store, in a state where a physical storage area in which data requested to be written to a logical storage area is to be stored without duplication is divided into a plurality of partial storage areas, where each of the plurality of partial storage areas includes a plurality of unit storage areas each serving as a data storage unit, and where the plurality of partial storage areas are grouped in a plurality of groups, a management table in which a record associated with each of the unit storage areas is registered, wherein the management table is divided into group regions respectively associated with the plurality of groups, in each of the group regions, the records associated with the unit storage areas included in the partial storage areas belonging to the associated group among the plurality of groups are registered, each of the records contains a first hash value based on data stored in the associated unit storage area and location information of the associated unit storage area, and the processor is configured to: select a first partial storage area as a processing target from among the plurality of partial storage areas; identify a first group to which the first partial storage area belongs among the plurality of groups; search the records included in a first group region associated with the first group among the group regions included in the management table to find a first record associated with each of the unit storage areas included in the first partial storage area, and delete the first hash value included in the first record in a case where the number of references from the logical storage area to data stored in the first partial storage area associated with the searched-out first record is 0.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating of a configuration example and a

processing example of a storage system according to a first embodiment;

FIG. 2 is a diagram illustrating a configuration example of a storage system according to a second embodiment;

FIG. 3 is a diagram illustrating a configuration example of processing functions included in a controller module (CM);

FIG. 4 is a diagram illustrating a comparative example of a hash table;

FIG. 5 is a diagram illustrating a data configuration example of a reference counter table;

FIG. 6 is an example of a flowchart presenting a data writing processing procedure in the comparative example;

FIG. 7 is an example of a flowchart presenting a hash value deletion processing procedure in the comparative example;

FIG. 8 is a diagram illustrating a data configuration example of a hash table in the second embodiment;

FIG. 9 is a diagram illustrating an example of calculation of duplication frequencies;

FIG. 10 is an example of a flowchart (1) presenting a data writing processing procedure;

FIG. 11 is an example of a flowchart (2) presenting the data writing processing procedure;

FIG. 12 is an example of a flowchart presenting a data deletion processing procedure; and

FIG. 13 is an example of a flowchart presenting a hash value deletion processing procedure.

### DESCRIPTION OF EMBODIMENTS

In some cases, a storage area of a storage device in which data is stored without duplication is divided and managed in multiple partial storage areas. In this case, each partial storage area includes multiple unit storage areas each serving as a data storage unit. In such a configuration, processing in which a hash value for the unit storage area whose reference counter is “0” is deleted from the management table is executed for each partial storage area in some cases.

According to this method, in a case where the hash value deletion processing is executed for a certain partial storage area, the management table has to be searched for the hash values for the unit storage areas belonging to the certain partial storage area. Since the entire management table is a search target in this search, there is a problem that a long time taken for the search results in a long time taken for the entire hash value deletion processing as well.

According to one aspect, an object of the present disclosure is to provide an information processing apparatus and an information processing method capable of reducing a time taken for processing of deleting an unnecessary hash value from a management table.

Hereinafter, embodiments of the present disclosure will be described with reference to the drawings.

### First Embodiment

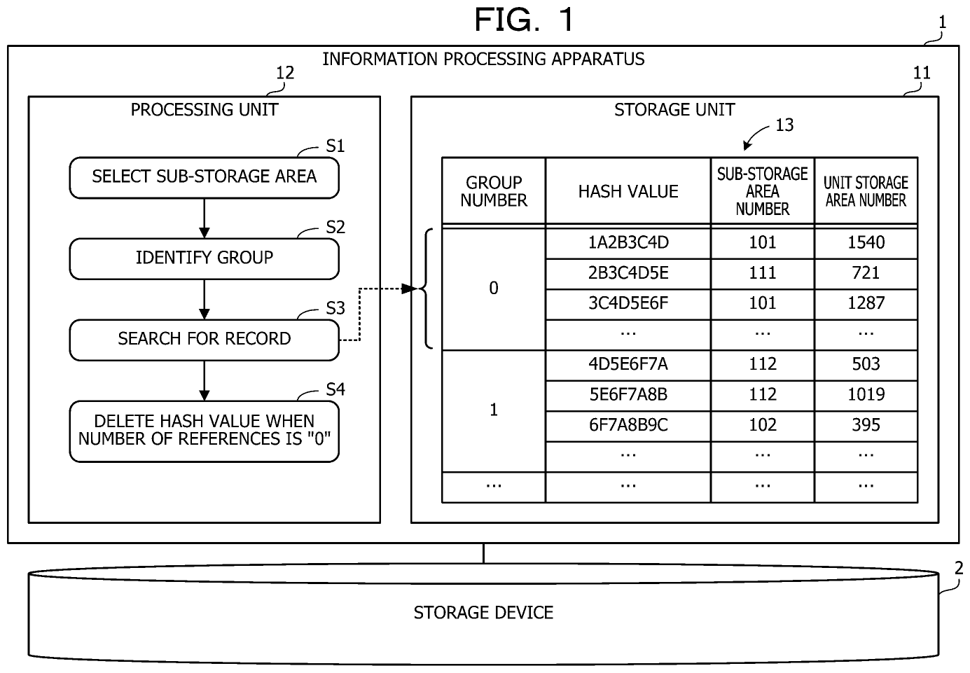

FIG. 1 is a diagram illustrating a configuration example and a processing example of a storage system according to a first embodiment. The storage system illustrated in FIG. 1 includes an information processing apparatus 1 and a storage device 2. The information processing apparatus 1 is an apparatus that controls access to the storage device 2. The information processing apparatus 1 is, for example, a server computer or a controller dedicated to storage control. The storage device 2 is, for example, a nonvolatile storage device. The storage devices 2 may include multiple nonvolatile storage devices.

In this storage system, the information processing apparatus 1 stores data, which is requested to be written to a logical storage area, in a physical storage area of the storage device 2 without duplication. The physical storage area of the storage device 2 is divided into multiple partial storage areas, and each of the multiple partial storage areas includes multiple unit storage areas each serving as a data storage unit. The multiple partial storage areas are classified into multiple groups.

In the example illustrated in FIG. 1, each partial storage area is identified by a partial storage area number, whereas the unit storage areas in the partial storage area are numbered with unit storage area numbers, which are determined in each partial storage area including unit storage areas. Accordingly, each unit storage area is identified by a combination of a partial storage area number and a unit storage area number. Each of the groups into which the partial storage areas are classified is identified by a group number.

The information processing apparatus 1 includes a storage unit 11 and a processing unit 12. The storage unit 11 is a storage area reserved in a storage device (not illustrated) included in the information processing apparatus 1. For example, the processing unit 12 is a processor (not illustrated) included in the information processing apparatus 1.

The storage unit 11 stores a management table 13. In the management table 13, a record associated with each of the unit storage areas is registered. Each record includes a hash value based on data stored in the associated unit storage area and location information of the unit storage area. In the example illustrated in FIG. 1, a combination of a partial storage area number and a unit storage area number is registered as the location information of the unit storage area.

The management table 13 is divided into group regions respectively associated with the above-described groups. In each of the group regions, records of the unit storage areas included in the partial storage areas belonging to the associated group are registered all together. In the example illustrated in FIG. 1, the partial storage areas with partial storage area numbers “101” and “111” are classified into a group with a group number “0”. In this case, the records for the unit storage areas included in the partial storage areas with the partial storage area numbers “101” and “111” are registered in the group region associated with the group number “0” among the regions in the management table 13.

The hash value in the management table 13 is used to determine whether the same data as data requested to be written to a logical storage area is already stored in any of the unit storage areas (for example, whether the data is redundant). In a case where data stored in a certain unit storage area is no longer referred to from any logical storage area, the hash value for the data is unnecessary. For this reason, processing of deleting the unnecessary hash value from the management table 13 is executed in the following procedure. This hash value deletion processing is executed in a unit of partial storage area.

The processing unit 12 selects a processing target partial storage area from the multiple partial storage areas described above (step S1). Next, the processing unit 12 identifies a group to which the partial storage area selected in step S1 belongs from the multiple groups described above (step S2).

Subsequently, the processing unit 12 searches the records contained in the group region for the group identified in step S2 among the foregoing group regions included in the management table 13 to find out the records for the unit storage areas included in the partial storage area selected in step S1 (step S3). The processing unit 12 acquires the number of references from logical storage areas to data stored in the partial storage area associated with the searched-out records. When the acquired number of references is “0”, the processing unit 12 deletes the hash values contained in the searched-out records (step S4).

In step S3, the search range of the records in the management table 13 is limited to the group region for the group associated with the selected partial storage area. For example, the partial storage area with the partial storage area number “101” is assumed to be selected as a processing target in FIG. 1. In this case, the search range of the records in step S3 is limited to the group region for the group with the group number “0” to which the selected partial storage area belongs.

If the records in the management table 13 were not classified into groups, the search range of the records would be the entire management table 13. As compared with this case, the above-described processing by the processing unit 12 makes it possible to shorten the time taken for the search processing because the search range of the records is limited to the group region for the associated group. Resultantly, it is possible to shorten the time taken for the processing of deleting unnecessary hash values from the management table 13.

### Second Embodiment

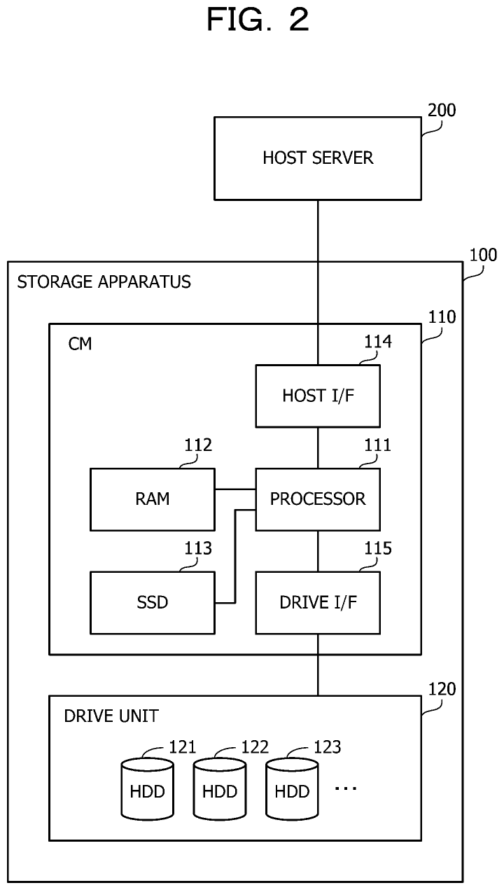

FIG. 2 is a diagram illustrating a configuration example of a storage system according to a second embodiment. The storage system illustrated in FIG. 2 includes a storage apparatus 100 and a host server 200. The storage apparatus 100 includes a controller module (CM) 110 and a drive unit 120.

The CM 110 is an example of the information processing apparatus 1 illustrated in FIG. 1. The CM 110 is coupled to the host server 200 via a storage area network (SAN) using, for example, a Fibre Channel (FC), an Internet small computer system interface (iSCSI), or the like. The CM 110 is a storage controller that controls access to storage devices mounted in the drive unit 120 in response to a request from the host server 200.

The drive unit 120 is an example of the storage device 2 illustrated in FIG. 1. The drive unit 120 is equipped with multiple storage devices to be accessed from the host server 200. In the present embodiment, for example, the drive unit 120 is a disk array device equipped with hard disk drives (HDDs) 121, 122, 123, . . . as storage devices. As the storage devices, another type of nonvolatile storage devices such as solid-state drives (SSDs) may be used.

The host server 200 is a server apparatus that executes various types of processing such as business processing, for example. While executing such processing, the host server 200 accesses storage areas provided by the storage apparatus 100. For example, the CM 110 generates logical volumes (logical storage areas) using the HDDs in the drive unit 120, and the host server 200 accesses the HDDs in the drive unit 120 by requesting the CM 110 to allow access to the logical volumes. As will be described later, such logical volumes are generated as virtual volumes to which physical areas are dynamically allocated. Multiple host servers 200 may be coupled to the CM 110.

A hardware configuration example of the CM 110 will be described using FIG. 2. The CM 110 includes a processor 111, a random-access memory (RAM) 112, an SSD 113, a host interface (I/F) 114, and a drive interface (I/F) 115.

The processor 111 centrally controls the entire CM 110. The processor 111 may be a multiprocessor. The processor 111 is, for example, a central processing unit (CPU), a microprocessor unit (MPU), a digital signal processor (DSP), an application-specific integrated circuit (ASIC), or a programmable logic device (PLD). The processor 111 may be a combination of two or more elements among a CPU, an MPU, a DSP, an ASIC, and a PLD.

The RAM 112 is used as a main storage device of the CM 110. The RAM 112 temporarily stores at least part of an operating system (OS) program and an application program to be executed by the processor 111. The SSD 113 is used as an auxiliary storage device of the CM 110. The SSD 113 stores the OS program, the application program, and various types of data.

The host interface 114 is a communication interface for communicating with the host server 200. The drive interface 115 is a communication interface for communicating with the drive unit 120. For example, the drive interface 115 is a Serial Attached SCSI (SAS) interface.

The above hardware configuration implements processing functions of the CM 110.

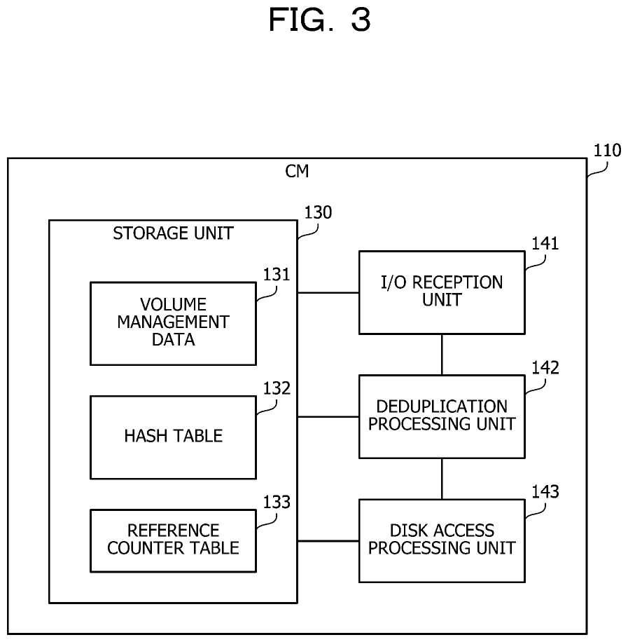

FIG. 3 is a diagram illustrating a configuration example of the processing functions included in the CM. As illustrated in FIG. 3, the CM 110 includes a storage unit 130, an input/output (I/O) reception unit 141, a deduplication processing unit 142, and a disk access processing unit 143.

The storage unit 130 is a storage area reserved in a storage device such as the RAM 112 or the SSD 113 included in the CM 110. The storage unit 130 stores a volume management data 131, a hash table 132, and a reference counter table 133.

The CM 110 generates a virtual volume to be accessed from the host server 200. On the virtual volume, only an area in which data is written in response to a request from the host server 200 is assigned a physical area from a storage pool. The storage pool is a storage area implemented by using the multiple HDDs equipped in the drive unit 120 and shared by one or more virtual volumes.

In writing data to a virtual volume, deduplication processing is executed so that the data may not be redundantly stored. For example, the storage pool is divided and managed in slots of a certain size, and physical areas in units of slots are allocated to a virtual volume. Write data to be written to a virtual volume is divided into logical blocks each having the same size as the slot. Only when a slot storing the same data as each of the divided logical blocks does not exist, a new slot is allocated to the logical block and the data of the logical block is stored in the allocated slot.

The volume management data 131 is management data about virtual volumes. For example, the volume management data 131 includes configuration information of a virtual volume, information indicating an association relationship between each of the logical blocks on the virtual volume and an allocated slot, and the like.

The hash table 132 and the reference counter table 133 are management data involved in the deduplication processing. In the hash table 132, a hash value calculated based on data in each slot and location information of the slot are registered in association with each other. In the reference counter table 133, a count value of a reference counter is registered for each slot. The count value indicates how many logical blocks refer to the data in the slot (for example, the number of duplications of the data in the slot).

Since the hash values registered in the hash table 132 are referred to for duplication determination, it is desirable to store the hash table 132 in a memory accessible at high speed (for example, the RAM 112). For this purpose, the hash table 132 is sometimes stored in a memory, which is used as a cache area during I/O processing on a virtual volume, and in this case, the hash table 132 is called “Hash cash”.

The processing of the I/O reception unit 141, the deduplication processing unit 142, and the disk access processing unit 143 is implemented, for example, by the processor 111 executing predetermined application programs.

The I/O reception unit 141 receives an I/O request (such as a write request or a read request) for a virtual volume from the host server 200, and responds that the processing according to the request is completed.

The deduplication processing unit 142 divides write data requested to be written into logical blocks and allocates a slot from the storage pool to each of the logical blocks. In this allocation, the deduplication processing unit 142 allocates the same slot to logical blocks containing the same data so that the same data may not be redundantly stored in the storage pool.

The disk access processing unit 143 reads and writes data from and to the slots. In a case where the storage pool is built as a redundant array of inexpensive disks (RAID) volume (a logical storage area controlled according to RAID), the disk access processing unit 143 controls the writing of data to the slots according to RAID.

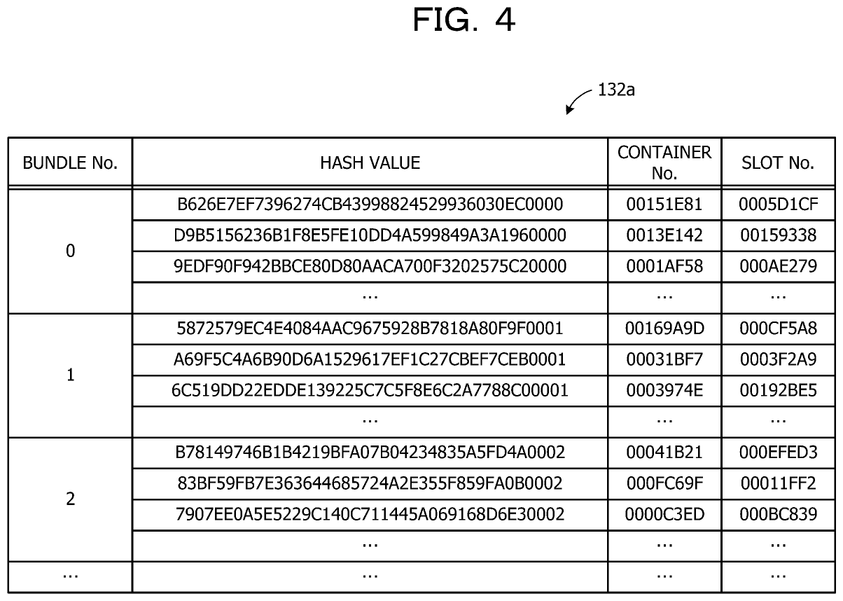

Next, a comparative example of deduplication processing will be described by using FIG. 4 to FIG. 7 and then deduplication processing according to the second embodiment will be described.

FIG. 4 is a diagram illustrating a comparative example of the hash table. A hash table 132a illustrated in FIG. 4 is a comparative example of the hash table 132 illustrated in FIG. 3.

In the present comparative example, a storage pool serving as an allocation source of physical areas to a virtual volume is divided and managed in containers of a certain size (for example, 16 GB). Each container is subdivided into slots of a certain size. Each container is given a container number (container No.) for identifying the container and each slot included in each container is given a slot number (slot No.) for identifying the slot. The slot number specifies a location of the slot in the container. Accordingly, each slot in the storage pool is specified by a combination of a container number and a slot number.

The container is built in areas with sequential addresses on the storage pool. Slots with sequential slot numbers in the same container are set in adjacent areas on the storage pool.

In the present comparative example, slots each identified by a combination of a container number and a slot number are grouped and managed by a certain number (for example, 128 slots). This group herein is referred to as a “bundle”. The bundle is identified by a bundle number (bundle No). The bundle to which a slot belongs is uniquely specified by a specific calculation using a hash value for the slot. For example, the bundle number of the bundle to which a slot belongs is calculated, defined as the remainder of the hash value for the slot divided by the total number of bundles.

Accordingly, in each record of the hash table 132a illustrated in FIG. 4, a combination of a container number and a slot number for identifying a slot, a hash value calculated based on data stored in the slot, and a bundle number of a bundle to which the slot belongs are registered in association with each other.

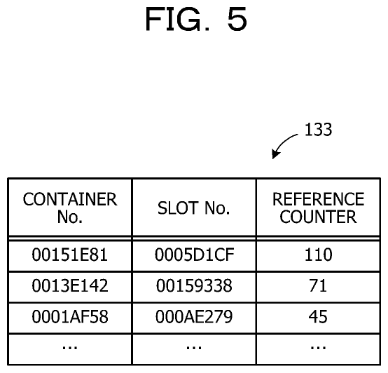

FIG. 5 is a diagram illustrating a data configuration example of a reference counter table. In the reference counter table 133, the count value of the reference counter (hereafter, simply referred to as the “reference counter”) is registered for each slot as described above. When the slots are managed as described above, a reference counter and a combination of a container number and a slot number are registered in association with each other in the reference counter table 133 as illustrated in FIG. 5.

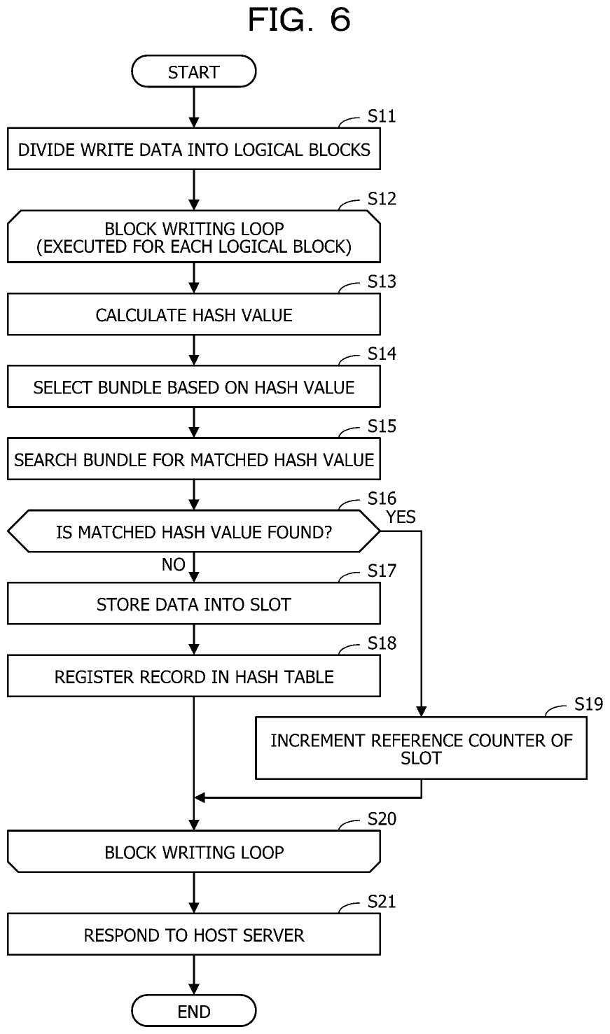

FIG. 6 is an example of a flowchart presenting a data writing processing procedure in the comparative example.

[STEP S11] The I/O reception unit 141 receives a data write request to a virtual volume together with write data from the host server 200. The deduplication processing unit 142 divides the write data into logical blocks of the same size as the slot.

[STEP S12] A block writing loop up to step S20 is executed. The block writing loop is executed on each of the divided logical blocks as a processing target.

[STEP S13] The deduplication processing unit 142 calculates a hash value based on the data in the logical block. The hash value is calculated, for example, by using a hash function of Secure Hash Algorithm (SHA)-1.

[STEP S14] The deduplication processing unit 142 selects a bundle based on the calculated hash value. For example, the deduplication processing unit 142 calculates a bundle number defined as the remainder of the hash value divided by the total number of bundles, and selects the bundle specified by the bundle number.

[STEP S15] The deduplication processing unit 142 searches the hash values registered in the records associated with the selected bundle among the records in the hash table 132a to find the hash value matched with the hash value calculated in step S13.

[STEP S16] The deduplication processing unit 142 determines whether or not the matched hash value exists. The processing proceeds to step S19 when the matched hash value exists, or proceeds to step S17 when the matched hash value does not exist.

[STEP S17] The deduplication processing unit 142 selects an available slot from the storage pool, and requests the disk access processing unit 143 to store the data in the logical block into the selected slot. In this selection, the deduplication processing unit 142 selects the slot in the adjacent area next to the slot selected in the previous data storage whenever possible. Thus, in the case of execution of sequential access, data pieces having neighboring logical addresses on the virtual volume are stored in adjacent areas on the storage pool, and as a result, the reading speed in data reading is improved.

The disk access processing unit 143 stores the data in the logical block into the slot according to the request from the deduplication processing unit 142.

[STEP S18] The deduplication processing unit 142 newly registers a record for the hash value calculated in step S13 in the hash table 132a. In this record, the bundle number calculated in step S14, the calculated hash value, and the container number and the slot number specifying the slot selected in step S17 are registered in association with each other.

The deduplication processing unit 142 newly registers a record in the reference counter table 133. In this record, the container number and the slot number specifying the slot selected in step S17 and an initial value “1” of the reference counter are registered.

The deduplication processing unit 142 registers the location of the logical block (for example, the head logical address of the logical block) on the virtual volume and the container number and the slot number specifying the selected slot in association with each other in the volume management data 131.

[STEP S19] The deduplication processing unit 142 extracts the container number and the slot number from the record having the matched hash value in the search in step S15. From the reference counter table 133, the deduplication processing unit 142 identifies the reference counter associated with the extracted container number and slot number, and adds “1” to the reference counter.

The deduplication processing unit 142 registers the location of the logical block (for example, the head logical address of the logical block) on the virtual volume and the container number and the slot number specifying the selected slot in association with each other in the volume management data 131.

[STEP S20] After the processing in steps S13 to S19 is executed for all the divided logical blocks, the processing proceeds to step S21.

[STEP S21] The I/O reception unit 141 transmits a response to the write request to the host server 200.

In the above-described processing, when the hash value based on data in a logical block requested to be written is not registered in the hash table 132, the data is determined to be non-redundant. In this case, the data in the logical block is stored in a new slot, and the logical block and the slot are associated with each other. The initial value “1” is registered as the reference counter for the hash value. On the other hand, when the hash value based on data in a logical block requested to be written is registered in the hash table 132, the data is determined to be redundant. In this case, the storage of the data in the logical block into the physical area is skipped, the logical block and the slot are associated with each other, and the reference counter for the hash value is incremented.

In step S15, in order to determine whether duplication occurs, the hash value matched with the hash value based on the data in the logical block is searched out from the hash table 132a. As illustrated in FIG. 4, in the hash table 132a, the hash values and the associated slots are grouped in the bundles. Since the bundle is uniquely determined from the hash value, the search target in step S15 is not the entire hash table 132a, but is limited to the range of the bundle selected in step S14 by using the hash value based on the data in the logical block. This makes it possible to shorten the search processing time on the hash table 132a for the duplication determination, and consequently shorten a response time for a write request from the host server 200.

Next, description will be given of a case where the I/O reception unit 141 receives a request to delete data from a virtual volume from the host server 200. In this case, the following processing is executed for each of logical blocks included in the deletion target data on the virtual volume. The deduplication processing unit 142 identifies the slot associated with the logical block by referring to the volume management data 131. In the reference counter table 133, the deduplication processing unit 142 identifies the reference counter for the identified slot and subtracts “1” from the identified reference counter. In the volume management data 131, the deduplication processing unit 142 deletes the identification information (the container number and the slot number) of the slot associated with the logical block.

When update of data on a virtual volume is requested from the host server 200, the same processing as described above is executed for each of logical blocks included in the data before the update.

As described above, the reference counter is decremented by data deletion or update. When the reference counter becomes “0”, the data in the associated slot is no longer referred to by any logical block. In this case, the hash value for the slot is unnecessary and therefore it is desirable to delete this hash value from the hash table 132a.

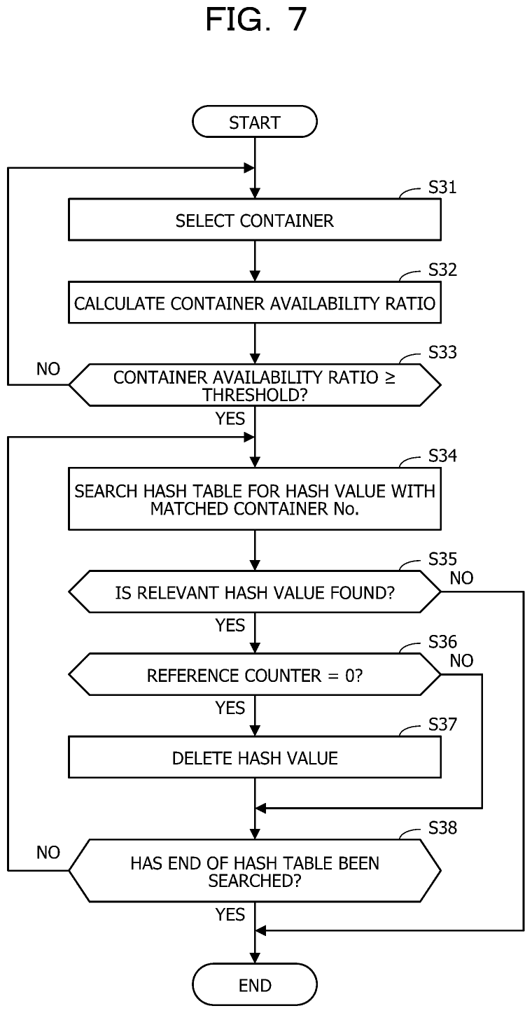

In the present comparative example, processing of monitoring the values of the reference counters and deleting the hash value for a slot with the reference counter “0” is executed as background processing under the I/O processing on a virtual volume. This processing is executed on a container-by-container basis as presented below in FIG. 7.

FIG. 7 is an example of a flowchart presenting a hash value deletion processing procedure in the comparative example.

[STEP S31] The deduplication processing unit 142 selects one container as a processing target. In this processing, the container next to the container subjected to the previous execution of the hash value deletion (step S37) (the container whose container number is larger by 1) is selected as the processing target. When the container subjected to the previous execution of the hash value deletion is the last container (the container with the largest container number) on the storage pool, the first container is selected.

[STEP S32] The deduplication processing unit 142 calculates a container availability ratio indicating a ratio of available slots in the processing target container. For example, the deduplication processing unit 142 acquires the reference counter associated with the container number of the processing target container from the reference counter table 133, and counts the number of slots with the reference counter “0”. The deduplication processing unit 142 calculates, as the container availability ratio, a ratio of the number of slots with the reference counter “0” to the total number of the slots included in the container.

[STEP S33] The deduplication processing unit 142 determines whether the calculated container availability ratio is equal to or higher than a predetermined threshold (for example, 30%). When the container availability ratio is equal to or higher than the threshold, the processing proceeds to step S34. On the other hand, when the container availability ratio is lower than the threshold, the processing proceeds to step S31, and the next container is selected.

[STEP S34] The deduplication processing unit 142 searches the hash values registered in the hash table 132a to find a hash value whose associated container number is matched with the container number of the processing target container. This search is performed sequentially from the head side of the hash table 132a.

[STEP S35] The deduplication processing unit 142 determines whether the relevant hash value is found by the search in step S34. The processing proceeds to step S36 when the relevant hash value is found, or the hash value deletion processing ends when the relevant hash value is not found.

[STEP S36] From the hash table 132a, the deduplication processing unit 142 acquires the container number and the slot number associated with the hash value found in step S35. The deduplication processing unit 142 acquires the reference counter associated with the container number and the slot number from the reference counter table 133 and determines whether the reference counter is “0”. The processing proceeds to step S37 when the reference counter is “0” or proceeds to step S38 when the reference counter is “1” or more.

[STEP S37] The deduplication processing unit 142 deletes the record containing the hash value found in step S35 from the hash table 132a. As a result, the hash value for the slot with the reference counter “0” is deleted. The slot associated with the deleted record turns into an available state (released state), and is ready to be allocated to another logical block.

[STEP S38] The deduplication processing unit 142 determines whether the end of the hash table 132a has been searched by the search processing in step S34. When the end of the hash table 132a has not been searched (for example, when the record containing the hash value found in step S35 is not the last record in the hash table 132a), the processing proceeds to step S34. In this case, in step S34, the search is continued from the record next to the record containing the hash value found in step S35. On the other hand, when the end of the hash table 132a has been searched, the hash value deletion processing ends.

In the above-described processing, the ratio of slots with the reference counter “0” (the container availability ratio) is calculated on the container-by-container basis and the container, the above ratio of which is equal to or higher than the threshold, is subjected to the hash value deletion. Each container is built in consecutive areas on the storage pool. Thus, for example, in response to a request to write a large volume of data or the like, one container is likely to store the data at the same or close timing. Accordingly, data stored in one container is likely to be deleted at the same or close timing. The hash value deletion on the container-by-container basis as described above leads to an increase in the possibility that the hash values for a relatively large number of slots may be deleted at once, therefore achieving the highly efficient deletion processing.

In the hash value deletion processing illustrated in FIG. 7, the search target in searching the hash table 132a to find the hash value for each of the slots included in a deletion target container (corresponding to step S34) is the entire hash table 132a. As the number of records in the hash table 132a (for example, the number of slots in the storage pool) increases, the time taken for the search processing increases. In recent years, with a tendency of increasing the capacity of a virtual volume, the capacity of a storage pool that is an allocation source of physical areas, for example, the number of slots in the storage pool has been increasing. For this reason, there is a problem that the hash value search processing on the hash table 132a for the target container is lengthened, and the search processing load increases. As the search processing load increases, the I/O processing speed for the virtual volume may possibly decrease.

Also in the data writing processing illustrated in FIG. 6, a hash value is searched out from the hash table 132a in step S15. Although the search range in this processing is limited to the range of one bundle as described above, the search processing time similarly increases as the capacity of the storage pool increases. To address this, it is desirable to shorten this search processing time.

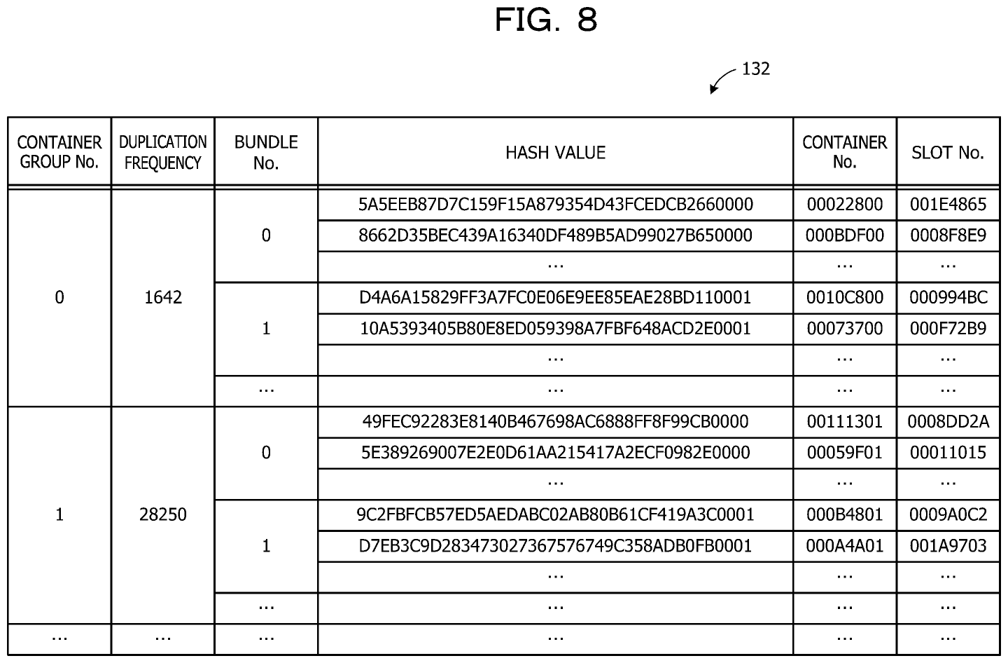

To this end, the second embodiment uses the hash table 132 as illustrated below in FIG. 8. By using the hash table 132, the time taken for a hash value search is shortened.

FIG. 8 is a diagram illustrating a data configuration example of a hash table according to the second embodiment. In the present embodiment, containers are classified into multiple container groups. A container group to which a certain container belongs is uniquely determined from the container number of the container. For example, a container group number (container group No.) for identifying the associated container group is calculated, defined as the remainder of the container number of the container divided by the total number of container groups.

As illustrated in FIG. 8, records each containing a hash value, a container number, and a slot number for each container group are registered all together in the hash table 132 in the present embodiment. The records are classified into bundles determined by the hash values in the same manner as in the hash table 132a illustrated in FIG. 4. Accordingly, in a table region associate with one container group in the hash table 132, the records are sub-divided into bundles and the records in each bundle are registered all together.

In the hash table 132, a duplication frequency is registered for each container group. The duplication frequency is a total value of the reference counters for the respective slots belonging to a container group.

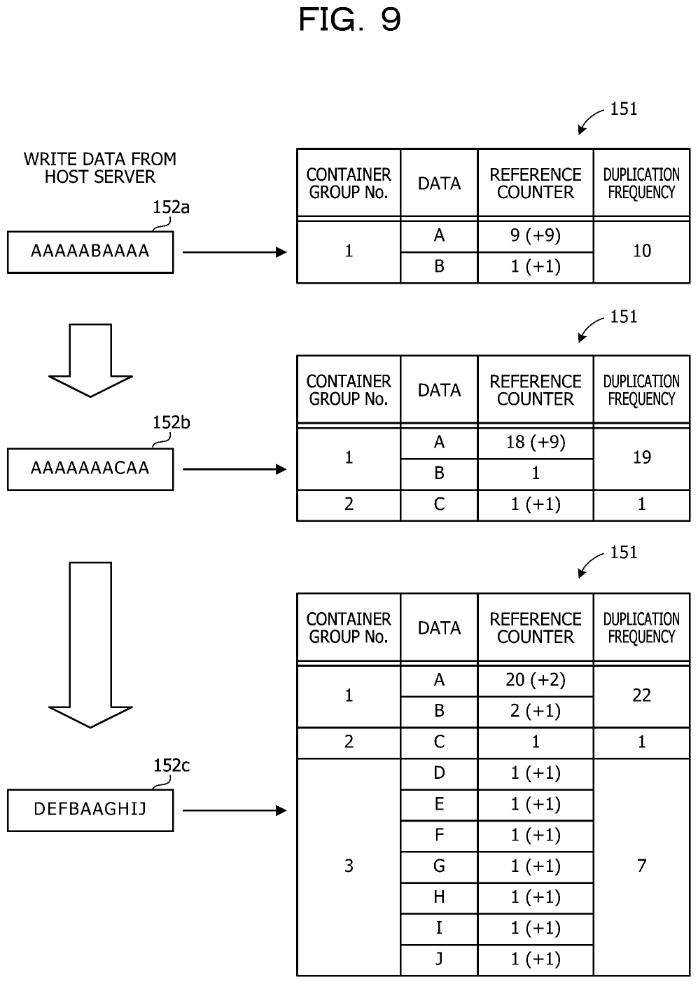

FIG. 9 illustrates an example of calculation of duplication frequencies. A table 151 illustrated in FIG. 9 presents the container group number of a container group to which slots belong, data pieces stored in the slots, the reference counters for the slots, and the duplication frequency for the container group in association with each other in an easily understandable manner. Each of alphabets contained in write data represents a data piece in one of logical blocks contained in the write data.

First, the host server 200 makes a write request of write data 152a to a virtual volume. The write data 152a contains nine data pieces A and one data piece B. When the data pieces A and B are stored in slots in the same container belonging to a container group number “1”, the reference counters for the slots in which the data pieces A and B are stored are “9” and “1”, respectively. In this case, the duplication frequency for the container group number “1” is “10”.

Next, the host server 200 makes a write request of write data 152b to the virtual volume. The write data 152b contains nine data pieces A and one data piece C. In this case, the reference counter for the slot in which the data A is stored is updated to “18”, and the duplication frequency for the container group number “1” is updated to “19”. The data piece C is stored in a slot in a container belonging to a container group number “2”. In this case, the reference counter for the slot in which the data C is stored is “1”, and the duplication frequency for the container group number “2” is “1”.

Next, the host server 200 makes a write request of write data 152c to the virtual volume. The write data 152c contains two data pieces A, and one data pieces B and D to J. In this case, the reference counter for the slot in which the data A is stored is updated to “20”, the reference counter for the slot in which the data B is stored is updated to “2”, and the duplication frequency for the container group number “1” is updated to “22”. The data pieces D to J are stored in slots in a container belonging to a container group number “3”. In this case, the reference counters for the slots in which the data pieces D to J are respectively stored are “1”, and the duplication frequency for the container group number “3” is “7”.

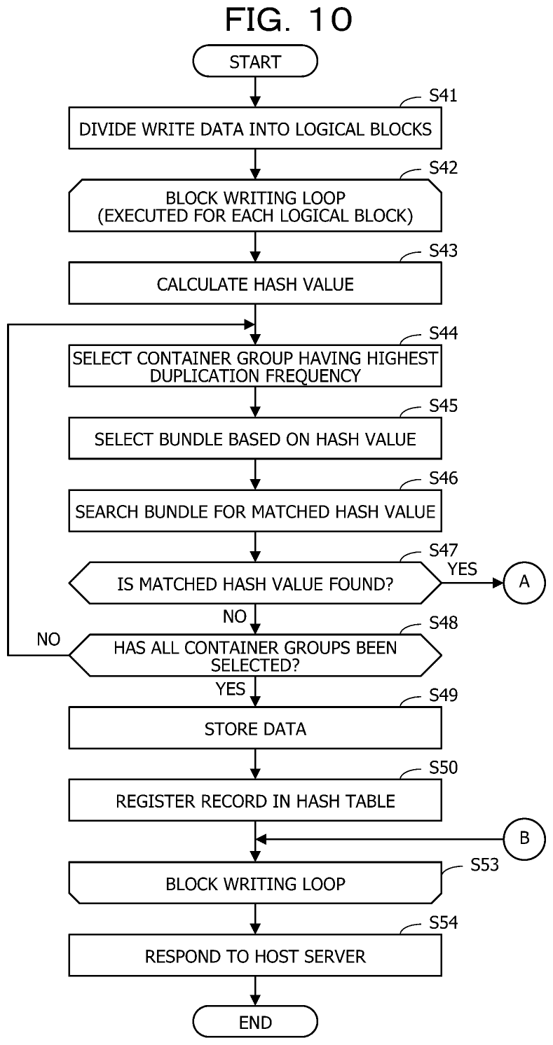

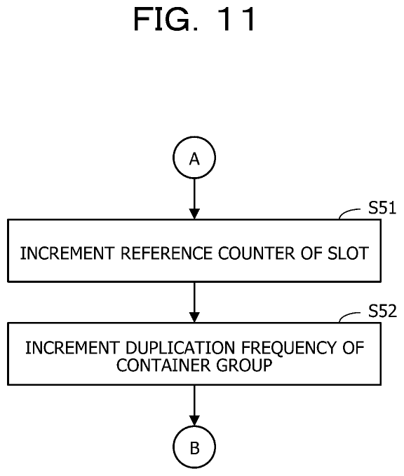

The duplication frequency calculated in this manner has the following characteristic. A higher duplication frequency means that when write requests of data to the virtual volume were made in the past, data pieces in logical blocks contained in the data were more frequently redundant with the data pieces in the slots belonging to the container group associated with the duplication frequency. For this reason, in a case where a write request of data to the virtual volume is made in future, a container group having a higher duplication frequency presumably has a higher possibility that a data piece in each of the logical blocks will be redundant with any of the data pieces in the slots belonging to the container group. Accordingly, in the data writing processing illustrated in FIGS. 10 and 11, a search hit may be expected to occur early by sequentially selecting the container group in descending order of the duplication frequency as the search range of the hash values.

FIGS. 10 and 11 are flowcharts illustrating an example of a data writing processing procedure.

[STEP S41] The I/O reception unit 141 receives a data write request to a virtual volume together with write data from the host server 200. The deduplication processing unit 142 divides the write data into logical blocks of the same size as the slot.

[STEP S42] A block writing loop up to step S53 is executed. The block writing loop is executed on each of the divided logical blocks as a processing target.

[STEP S43] The deduplication processing unit 142 calculates a hash value based on the data in the logical block.

[STEP S44] The deduplication processing unit 142 selects the container group having the highest duplication frequency by referring to the hash table 132.

[STEP S45] The deduplication processing unit 142 selects a bundle based on the hash value calculated in step S43. For example, the deduplication processing unit 142 calculates a bundle number defined as the remainder of the hash value divided by the total number of bundles, and selects the bundle specified by the bundle number. This bundle selection may be executed immediately after step S43.

[STEP S46] The deduplication processing unit 142 searches the hash values registered in the records associated with the container group selected in step S44 and associated with the bundle selected in step S45 among the records in the hash table 132 to find the hash value matched with the hash value calculated in step S43.

[STEP S47] The deduplication processing unit 142 determines whether or not the matched hash value exists. The processing proceeds to step

S51 when the matched hash value exists, or proceeds to step S48 when the matched hash value does not exist.

[STEP S48] The deduplication processing unit 142 determines whether all the container groups have been selected in step S44. When there are unselected container groups, the processing proceeds to step S44, and the container group having the highest duplication frequency is selected from the unselected container groups. On the other hand, when the matched hash value does not exist, the processing proceeds to step S49.

[STEP S49] The deduplication processing unit 142 selects an available slot from the storage pool, and requests the disk access processing unit 143 to store the data in the logical block into the selected slot. In this selection, the deduplication processing unit 142 selects the slot in the adjacent area next to the slot selected in the previous data storage whenever possible. Thus, in the case of execution of sequential access, data pieces having neighboring logical addresses on the virtual volume are stored in adjacent areas on the storage pool, and as a result, the reading speed in data reading is improved.

The disk access processing unit 143 stores the data in the logical block into the slot according to the request from the deduplication processing unit 142.

[STEP S50] The deduplication processing unit 142 newly registers a record for the hash value calculated in step S43 in the hash table 132. In this record, the calculated hash value and the container number and the slot number specifying the slot selected in step S49 are registered in association with each other. The deduplication processing unit 142 registers this record in one of the regions in the hash table 132 that is associated with the container group number based on the container number and is associated with the bundle number calculated in step S45.

The deduplication processing unit 142 newly registers a record in the reference counter table 133. In this record, the container number and the slot number specifying the slot selected in step S49 and an initial value “1” of the reference counter are registered. The deduplication processing unit 142 adds “1” to the duplication frequency associated with the container group number based on the container number among the duplication frequencies in the hash table 132.

The deduplication processing unit 142 registers the location of the logical block (for example, the head logical address of the logical block) on the virtual volume and the container number and the slot number specifying the selected slot in association with each other in the volume management data 131.

[STEP S51] The deduplication processing unit 142 extracts the container number and the slot number from the record having the matched hash value in the search in step S46. From the reference counter table 133, the deduplication processing unit 142 identifies the reference counter associated with the extracted container number and slot number, and adds “1” to the reference counter.

The deduplication processing unit 142 registers the location of the logical block (for example, the head logical address of the logical block) on the virtual volume and the container number and the slot number specifying the selected slot in association with each other in the volume management data 131.

[STEP S52] The deduplication processing unit 142 adds “1” to the duplication frequency associated with the container group number based on the container number among the duplication frequencies in the hash table 132.

[STEP S53] After the processing in steps S43 to S51 is executed for all the divided logical blocks, the processing proceeds to step S54.

[STEP S54] The I/O reception unit 141 transmits a response to the write request to the host server 200.

In the above-described processing, the container group is selected in descending order of the duplication frequency in step S44, and the hash value search in step S46 is executed with the selected container group set as the search range. In a case where a write request of data to the virtual volume is made, a container group having a higher duplication frequency presumably has a higher possibility that a data piece in each of the logical blocks will be redundant with any of the data pieces in the slots belonging to the container group as described above. For this reason, the hash value search performed by selecting the container group in descending order of the duplication frequency as described above results in an increase in the possibility that a matched hash value is found early before all the container groups are selected. As the number of container groups selected until a matched hash value is found is smaller, for example, as the matched hash value is found earlier, the search range of the hash values is narrower and the time taken for the search is shorter as compared with the case of the comparative example in FIG. 6. Therefore, the above-described processing makes it possible to shorten the average time taken for the hash value search for the duplication determination. As a result, it is possible to shorten the response time for a write request to the host server 200.

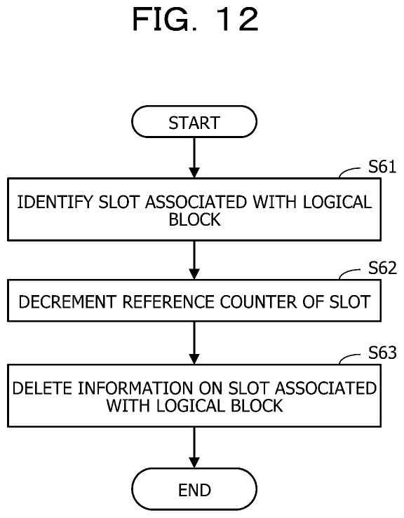

FIG. 12 is a flowchart illustrating an example of a data deletion processing procedure. The I/O reception unit 141 receives a request to delete data from a virtual volume from the host server 200. In this case, the processing in FIG. 12 is executed for each of logical blocks included in the deletion target data on the virtual volume.

[STEP S61] The deduplication processing unit 142 identifies the slot associated with the logical block by referring to the volume management data 131.

[STEP S62] In the reference counter table 133, the deduplication processing unit 142 identifies the reference counter for the identified slot and subtracts “1” from the identified reference counter.

[STEP S63] In the volume management data 131, the deduplication processing unit 142 deletes the identification information (the container number and the slot number) of the slot associated with the logical block.

When update of data on a virtual volume is requested from the host server 200, the processing in FIG. 12 is executed for each of logical blocks included in the data before the update.

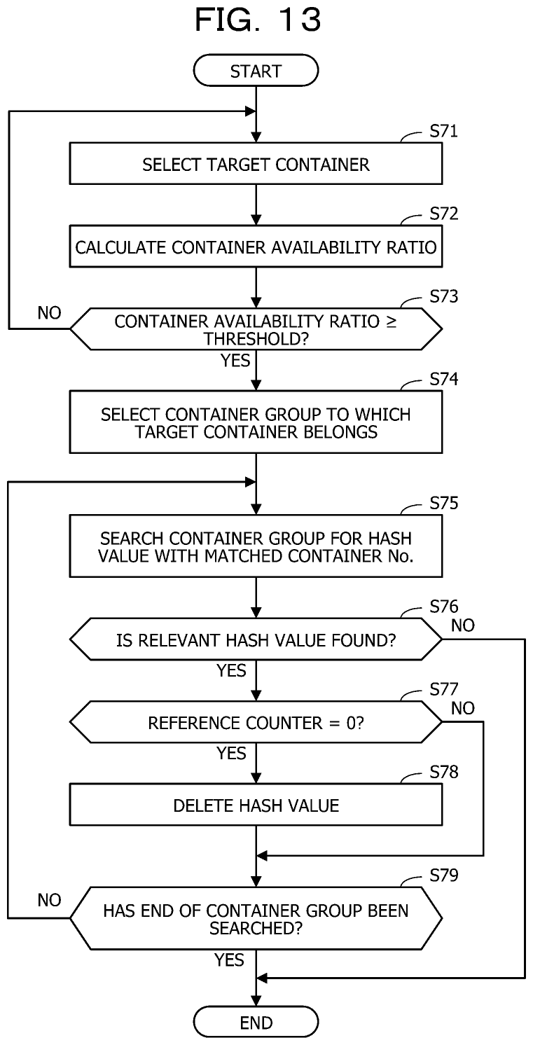

FIG. 13 is an example of a flowchart presenting the hash value deletion processing procedure.

[STEP S71] The deduplication processing unit 142 selects one container as a processing target. In this processing, the container next to the container subjected to the previous execution of the hash value deletion (step S78) (the container whose container number is larger by 1) is selected as the processing target. When the container subjected to the previous execution of the hash value deletion is the last container (the container with the largest container number) on the storage pool, the first container is selected.

[STEP S72] The deduplication processing unit 142 calculates a container availability ratio indicating a ratio of available slots in the processing target container. For example, the deduplication processing unit 142 acquires the reference counter associated with the container number of the processing target container from the reference counter table 133, and counts the number of slots with the reference counter “0”. The deduplication processing unit 142 calculates, as the container availability ratio, a ratio of the number of slots with the reference counter “0” to the total number of the slots included in the container.

[STEP S73] The deduplication processing unit 142 determines whether the calculated container availability ratio is equal to or higher than a predetermined threshold (for example, 30%). When the container availability ratio is equal to or greater than the threshold, the processing proceeds to step S74. On the other hand, when the container availability ratio is less than the threshold, the processing proceeds to step S71, and the next container is selected.

[STEP S74] The deduplication processing unit 142 selects the container group to which the processing target container belongs based on the container number of the processing target container. For example, a container group number for identifying the associated container group is calculated, defined as the remainder of the container number of the processing target container divided by the total number of container groups.

[STEP S75] The deduplication processing unit 142 sets, as a search range, the region of the records included in the container group selected in step S74 in the region of the hash table 132 and searches the hash values registered within the search range in the hash table 132 to find a hash value whose associated container number is matched with the container number of the processing target container. This search is performed sequentially from the head side in the search range.

[STEP S76] The deduplication processing unit 142 determines whether the relevant hash value is found by the search in step S75. The processing proceeds to step S77 when the relevant hash value is found, or the hash value deletion processing ends when the relevant hash value is not found.

[STEP S77] From the hash table 132, the deduplication processing unit 142 acquires the container number and the slot number associated with the hash value found in step S76. The deduplication processing unit 142 acquires the reference counter associated with the container number and the slot number from the reference counter table 133 and determines whether the reference counter is “0”. The processing proceeds to step S78 when the reference counter is “0” or proceeds to step S79 when the reference counter is “1” or more.

[STEP S78] The deduplication processing unit 142 deletes the record containing the hash value found in step S76 from the hash table 132. As a result, the hash value for the slot with the reference counter “0” is deleted. The slot associated with the deleted record turns into an available state (released state), and is ready to be allocated to another logical block.

[STEP S79] The deduplication processing unit 142 determines whether the end of the region for the selected container group in the hash table 132 has been searched by the search processing in step S34. When the end of the above region has not been searched (for example, when the record containing the hash value found in step S76 is not the last record in the above region), the processing proceeds to step S75. In this case, in step S75, the search is continued from the record next to the record containing the hash value found in step S76. On the other hand, when the end of the above region has been searched, the hash value deletion processing ends.

In the above-described processing, the search range of the hash values in the hash table 132 in step S75 is limited to the range of the container group to which the processing target container belongs. For this reason, the search range of the hash values is narrower than that in the comparative example in FIG. 7. As a result, the time taken for the hash value search processing may be shortened, and the search processing load may be reduced. The reduced search processing load makes it possible to reduce the influence of the search processing load on the I/O processing for the virtual volume and improve the I/O processing speed.

In the second embodiment described above, an example has been described in which write data to be written to a virtual volume (logical storage area) is stored in a physical storage area without duplication. However, as another example, a file requested to be written may be stored in a physical storage area without data duplication. In this case, in writing the file, the file is divided into data blocks equivalent to the logical blocks described above, and it is determined whether each data block is redundant. The reference counter indicates the number of references from files.

The processing functions of the apparatuses (for example, the information processing apparatus 1 and the CM 110) described in each of the above embodiments may be implemented by a computer. In such a case, a program describing the details of the processing of the functions to be included in each apparatus is provided, and the above-described processing functions are implemented over the computer by executing the program with the computer. The program describing the details of the processing may be recorded in a computer-readable recording medium. Examples of the computer-readable recording medium include a magnetic storage device, an optical disk, a semiconductor memory, and the like. Examples of the magnetic storage device include a hard disk drive (HDD), a magnetic tape, and the like. Examples of the optical disk include a compact disc (CD), a Digital Versatile Disc (DVD), a Blu-ray disc (BD, registered trademark), and the like.

When the program is distributed, for example, a portable-type recording medium such as a DVD or a CD on which the program is recorded is sold. The program may also be stored in a storage device of a server computer and be transferred from the server computer to another computer via a network.

The computer that executes the program stores, in a storage device thereof, the program recorded on the portable-type recording medium or the program transferred from the server computer, for example. The computer reads the program from the storage device thereof and executes the processing according to the program. The computer may also read the program directly from the portable-type recording medium and execute the processing according to the program. Each time the program is transferred from the server computer coupled to the computer via the network, the computer may also sequentially execute the processing according to the received program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising a storage and a processor, wherein
the storage is configured to store, in a state where a physical storage area in which data requested to be written to a logical storage area is to be stored without duplication is divided into a plurality of partial storage areas, where each of the plurality of partial storage areas includes a plurality of unit storage areas each serving as a data storage unit, and where the plurality of partial storage areas are grouped in a plurality of groups, a management table in which a record associated with each of the unit storage areas is registered, wherein
the management table is divided into group regions respectively associated with the plurality of groups,
in each of the group regions, the records associated with the unit storage areas included in the partial storage areas belonging to the associated group among the plurality of groups are registered,
each of the records contains a first hash value based on data stored in the associated unit storage area and location information of the associated unit storage area, and
the processor is configured to:
select a first partial storage area as a processing target from among the plurality of partial storage areas;
identify a first group to which the first partial storage area belongs among the plurality of groups;
search the records included in a first group region associated with the first group among the group regions included in the management table to find a first record associated with each of the unit storage areas included in the first partial storage area, and
delete the first hash value included in the first record in a case where the number of references from the logical storage area to data stored in the first partial storage area associated with the searched-out first record is 0.

2. The information processing apparatus according to claim 1, wherein
the location information in the record includes a first identification number specifying a second partial storage area to which the associated unit storage area belongs among the plurality of partial storage areas, and a second identification number specifying a location of the associated unit storage area in the second partial storage area, and
the processor searches to find the first record by searching the records included in the first group region to find, as the first record, the record in which the first identification number specifying the first partial storage area is registered.

3. The information processing apparatus according to claim 1, wherein
in the management table, for each of the plurality of groups, a total value of the number of references to the data in the unit storage areas associated with the records in the associated group region is registered,
the processor is further configured to:
calculate a second hash value based on first data when writing of the first data is requested, and
select a second group region in descending order of the total value from among the group regions included in the management table,
search the records included in the selected second group region to find a second record in which the first hash value matched with the second hash value is registered,
when the second record is found, cancel selection of the second group region and skip storage of the first data into the physical storage area, and
when the second record is not found, select an available first unit storage area from the physical storage area, store the first data into the first unit storage area, and register a new record containing the location information specifying the first unit storage area and the second hash value as the first hash value in the management table.

4. The information processing apparatus according to claim 3, wherein
in the management table, the records included in each of the plurality of group regions are classified into a plurality of subgroups based on the first hash values, and
the processor is configured to search to find the second record by identifying a first subgroup from among the plurality of subgroups based on the second hash value, and searching the records belonging to the first subgroup among the records included in the second group region to find the second record.

5. An information processing method performed by a computer including a storage that is configured to store, in a state where a physical storage area in which data requested to be written to a logical storage area is to be stored without duplication is divided into a plurality of partial storage areas, where each of the plurality of partial storage areas includes a plurality of unit storage areas each serving as a data storage unit, and where the plurality of partial storage areas are grouped in a plurality of groups, a management table in which a record associated with each of the unit storage areas is registered, wherein the management table is divided into group regions respectively associated with the plurality of groups, in each of the group regions, the records associated with the unit storage areas included in the partial storage areas belonging to the associated group among the plurality of groups are registered, each of the records contains a first hash value based on data stored in the associated unit storage area and location information of the associated unit storage area,
the information processing method comprising:
selecting a first partial storage area as a processing target from among the plurality of partial storage areas;
identifying a first group to which the first partial storage area belongs among the plurality of groups;
searching the records included in a first group region associated with the first group among the group regions included in the management table to find a first record associated with each of the unit storage areas included in the first partial storage area, and
deleting the first hash value included in the first record in a case where the number of references from the logical storage area to data stored in the first partial storage area associated with the searched-out first record is 0.
